(19) United States
(12) Patent Application Publication
(10) Pub. No.: US 2024/0370650 A1
(43) Pub. Date: Nov. 7, 2024

(54) SPOKEN WORD AUDIO TRACK OPTIMIZER

(71) Applicant: Relevate Healthcare, Inc., Cincinnati, OH (US)

(72) Inventor: Christopher Mutkoski, Duxbury, MA (US)

(21) Appl. No.: 18/310,047

(22) Filed: May 1, 2023

(51) Int. Cl. G06F 40/289; G06F 40/103; G10L 15/26

(52) U.S. Cl. CPC G06F 40/289; G06F 40/103; G10L 15/26

(57) ABSTRACT

Implementations include systems, methods, and apparatuses comprising receiving a script selection; retrieving the script based on the script selection; sending the script to a user device; receiving a video recording attempt from the user device; generating, using a trained transcription machine learning model, a spoken word transcription from an audio track of the video recording attempt, the spoken word transcription including a deviation or the spoken word transcription from the script; determining, based on the deviation, whether the spoken word transcription satisfies a predetermined deviation condition; and: if the video recording attempt satisfies the predetermined deviation condition, sending the spoken word transcription to the user device via the network interface; or if the video recording attempt does not satisfy the predetermined deviation condition, sending the spoken word transcription and an instruction to re-record the video to the user device via the network interface.

### BACKGROUND

Marketing of medical products often involves the initiation of communication by sales representatives with healthcare providers (HCPs). Medical sales representatives often have strict rules as to what can be said and what cannot be said about a given product, resulting from government regulation and manufacturer guidelines.

### BRIEF DESCRIPTION OF THE FIGURES

For a fuller understanding of the nature and objects of the disclosure, reference should be made to the following detailed description taken in conjunction with the accompanying drawings, in which:

FIGS. 1A-1E illustrate an implementation of a spoken word audio track optimizer, according to one or more implementations;

FIG. 2 illustrates an operational environment, according to one or more implementations;

FIGS. 3-5 illustrate diagrams of example components of one or more devices of FIG. 2, according to one or more implementations;

FIG. 7 illustrates an artificial neural network (ANN), according to one or more implementations;

FIG. 8 illustrates a node, according to one or more implementations;

FIG. 9 illustrates a method of training a machine learning model of a machine learning module, according to one or more implementations; and

FIG. 10 illustrates a method of analyzing input data using a machine learning module, according to one or more implementations.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Conventional means of medical product marketing to HCPs often involves initiation of contact by a sales representative selling a given product. Certain compliance-oriented rules and restrictions as to what a sales representative may or may not say or write about a given product may be imposed, whether by government regulation or manufacturer guidelines.

When conducting marketing and sales activities, according to conventional methods, the sales representative must self-police, that is, the sales representative must be careful to make sure that restricted statements, phrases, words, or representations (collectively, “restricted words”) are not said on behalf of a product or manufacturer. The shortcoming of such a conventional method of self-policing by the sales representative is that certain restricted words may be missed. Further, manual checking requires re-checking, which may include the re-reading, re-listening, or re-watching of content after its creation but prior to delivery. This is particularly problematic for video and/or audio messages, as listening to an audio track takes time and may be prone to listener error.

Implementations may include systems, methods, and apparatuses for optimizing an audio track comprising spoken words. Such implementations may employ trained machine learning models to transcribe spoken words of an audio track (e.g., of a video), identify deviations within such a transcription, and/or determine whether any such deviations meet conditions requiring recreation of the audio track and/or video.

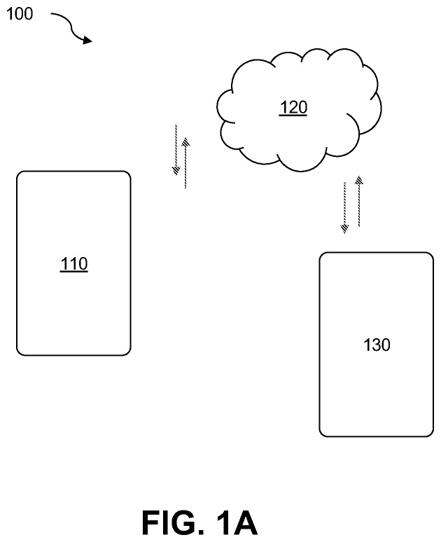

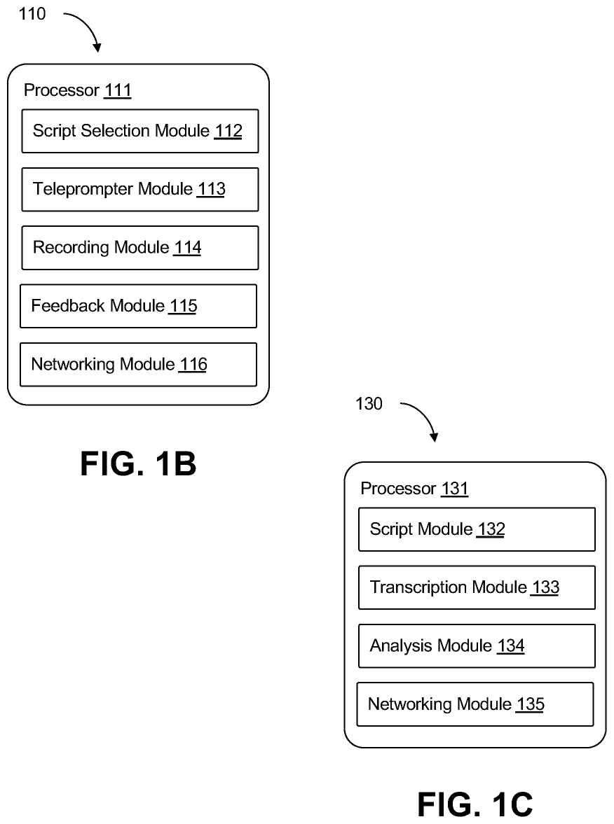

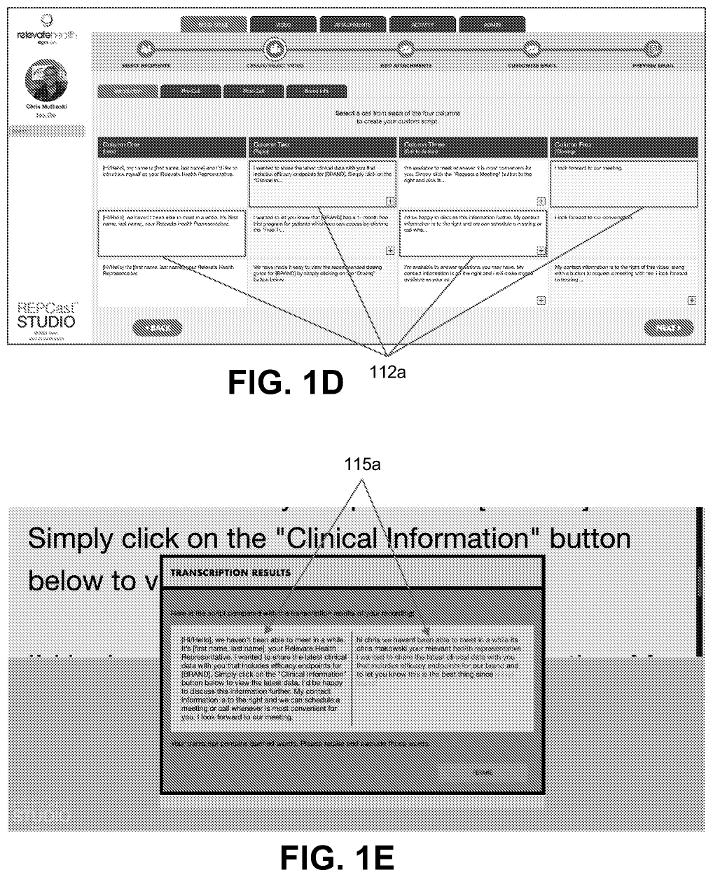

FIGS. 1A-1E illustrate implementations of spoken word audio track optimizers. Such implementations may assist healthcare sales representatives in preparing accurate and compliant content for delivery to target HCPs.

With reference to FIG. 1A, implementations of a system 100 for optimizing spoken word audio tracks may include a user device 110 and an application server 130, which may be in electronic communication via a network 120. User device 110 may interact with application server 130 via, for example, a mobile application or a web application.

With reference to FIG. 1B, user device 110 may include a processor 111 configured to execute machine-readable instructions for implementing various modules.

A script selection module 112 may provide for selection of a script by a user. Selection of the script may include selection of an entire script or a selection of various components or fragments (e.g., partials) of a script (e.g. script fragment selections 112a illustrated in FIG. 1D). In the latter example, the script selection may include a plurality of script fragment selections. In this example, retrieving the script from the database may thus include retrieving a plurality of script fragments corresponding to the script fragment selections. The full script may then be compiled from the script fragments.

Processor 111 may include a networking module 116 configured to cause user device 110 to transmit the script selection and or a video recording attempt to application server 130 via network 120. Also using networking module 116, processor 111 may receive a script from application server 130 via network 120.

A teleprompter module 113 may provide for display of a script (e.g., a compiled script received from the application server 130). Teleprompter module 113 may present the script in a readable format while a user is recording a video using user device 110.

A recording module 114 may provide for recording of video and/or audio via user device 110 (e.g., a video recording attempt). Such recording may be performed using a camera and/or microphone onboard user device 110. Recording module 114 may be configured to store the recorded file in a format readable by user device 110, application server 130, and transferable therebetween.

A feedback module 115 may provide for presentation of feedback received by user device 110 via, for example, a display of user device 110 (e.g., a script-transcript comparison 115a of FIG. 1E). Such feedback may include a script-transcript comparison, highlighted deviations, severity of deviations, and/or whether the video/audio must be re-recorded.

With reference to FIG. 1C, application server 130 may include a processor 131 configured to execute machine-readable instructions for implementing various modules.

A script module 132 may provide for retrieving a script from a database stored on an electronic storage device in electronic communication with the processor based on the script selection received from user device 110 via network 120. The script selection may include a selection of an entire script or a selection of fragments and/or fragments (e.g., portions) of a script. In the latter example, script module 132 may be configured to compile the script fragments into the script. Script module 132 may further be configured to format the script for teleprompter use.

Processor 131 may include a networking module 135 configured to receive a script selection and/or a video recording attempt from user device 110 via network 120. Also using networking module 135, processor 131 may transmit a script to user device 110 via network 120.

A transcription module 133 may provide for generating, using a trained transcription machine learning model, a spoken word transcription from an audio track of the video recording attempt. The audio track may be separated from the video, and in some implementations, only the audio track is transmitted from user device 110 to application server 130. The trained transcription machine learning model may be trained, for example, using a training audio track and training spoken word transcription corresponding to the training audio track.

An analysis module 134 may provide for determining whether a spoken word transcription satisfies a predetermined deviation condition. The predetermined deviation condition may include a measure of deviation (e.g., the differences) of the spoken word transcription from the script. Thus, the spoken word transcription may include a deviation of the spoken word transcription from the script. The deviation(s) may include restricted words (e.g., noncompliant words, phrases, statements, or representations). Deviations may be scored with a severity. For example, some deviations may be acceptable, for example, the use of “hello” compared to “hi there.” Other deviations, such as the use of prohibited words, may be more severe and carry potential repercussions for the sales representative and/or the entity which the sales representative represents (e.g., the healthcare product manufacturer). The predetermined deviation condition may include whether a restricted word or phrase is present within the spoken word transcription. Analysis module 134 may determine whether a predetermined deviation condition is met, for example, using a trained deviation evaluation machine learning model. The trained deviation evaluation machine learning model may be trained using a training spoken word transcription and a training condition evaluation set.

The predetermined deviation condition may in such implementations include whether the severity exceeds a deviation severity threshold.

Processor 131 may be configured to, if the video recording attempt satisfies the predetermined deviation condition, send the spoken word transcription via networking module 135. Otherwise, processor 131 may be configured to, if the video recording attempt does not satisfy the predetermined deviation condition, sending the spoken word transcription and an instruction to re-record the video via networking module 135.

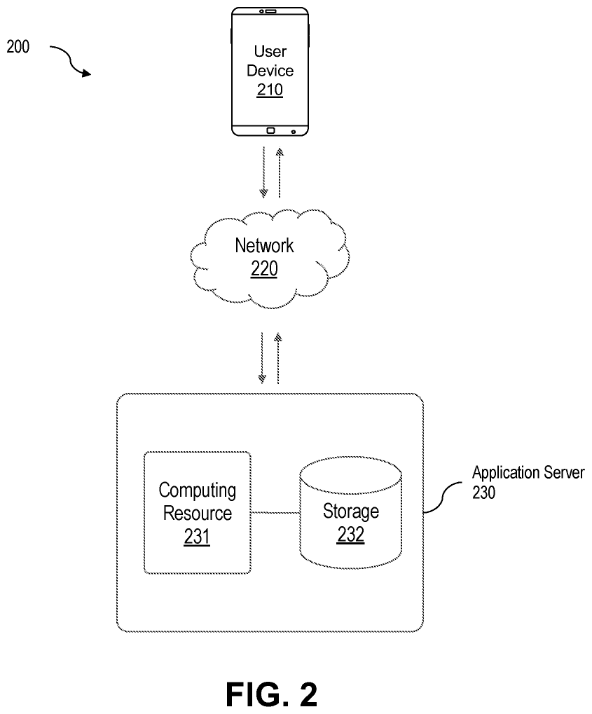

FIG. 2 Illustrates an operational environment 200 for one or more of the implementations herein. As illustrated in FIG. 2, environment 200 may include actors, including a user device 210, a network 220, an application server 230 having at least a computing resource 231 and a storage 232.

User device 210 may include any variety of devices a user may use to interface with application server 230 via network 220, including, for example, a server, a desktop computer, a laptop computer, a handheld computer, a tablet computing platform, a Netbook, a Smartphone, a gaming console, and/or other computing platforms.

Network 220 may include any variety of devices

Application server 230 may include any variety of devices configurable to perform the implementations and methods disclosed herein and interface with user device 210 via network 220, including, for example, a server, a desktop computer, a laptop computer, a handheld computer, a tablet computing platform, a Netbook, a Smartphone, a gaming console, and/or other computing platforms.

Application server 230 may include computing resource 231. Computing resource 231 may include, for example, one or more processor(s) configured to execute machine-readable instructions for implementing all or some of the implementations herein. Computing resource 231 may be configured to access storage 232 to retrieve and/or write electronic data from and to storage 232.

Application server 230 may include storage 232. Storage 232 may be configured to host one or more databases or other forms of data storage for use in implementations herein. Storage 232 may be accessible by computing resource 231.

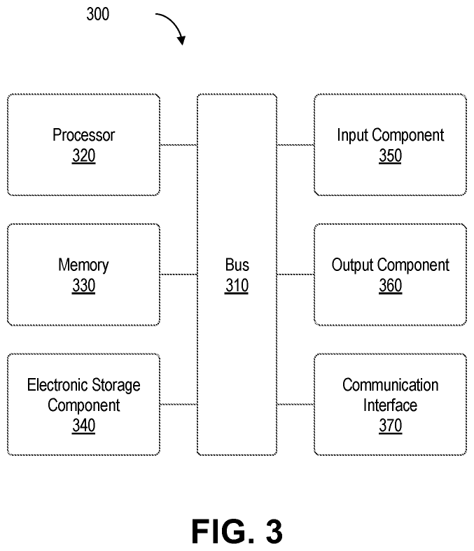

FIG. 3 is a diagram of example components of a device 300, which may correspond to user device 210 and/or application server 230. In some implementations, user device 210 and/or application server 230 may include one or more devices 300 and/or one or more components of device 300, for example, according to a client/server architecture, a peer-to-peer architecture, and/or other architectures, which may include a plurality of hardware, software, and/or firmware components operating together to provide the functionality attributed herein to device 300. In some implementations, device 300 may include a distributed computing architecture (e.g., one or more individual computing platforms operating in concert to accomplish a computing task). For example, device 300 may be implemented by a cloud of computing platforms operating together as device 300. By way of non-limiting example, a given device 300 may include one or more of a server, a desktop computer, a laptop computer, a handheld computer, a tablet computing platform, a Netbook, a Smartphone, a gaming console, and/or other computing platforms.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300.

Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Such processors may or may not be all integral to the same physical device, and may in some embodiments be distributed among several devices.

Processor 320 may be configured to execute one or more of the modules disclosed herein, and/or other modules by software; hardware; firmware; some combination of software, hardware, and/or firmware; and/or other mechanisms for configuring processing capabilities on processor 320. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using system libraries, language libraries, model-view-controller (MVC) principles, application programming interfaces (APIs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB.Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired.

It should be appreciated that although some modules disclosed herein may be illustrated for example as being implemented within a single processing unit, in embodiments in which processor 320 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, processor 320 may be configured to execute one or more additional modules that may perform some or all of the functionality attributed herein to one of modules disclosed herein.

Memory 330 includes a random-access memory, a read only memory, and/or another type of memory (e.g., a flash memory, a magnetic memory, and/or an optical memory).

Electronic storage component 340 stores information and/or software related to the operation of device 300. For example, electronic storage component 340 may include a hard disk drive, a magnetic disk drive, an optical disk drive, a solid-state disk drive, a compact disc, a digital versatile disc, and/or another type of non-transitory computer-readable medium. Implementations of electronic storage component 340 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Implementations of electronic storage component 340 may include one or both of system storage provided integrally (i.e., substantially non-removable) to device 300 and/or removable storage that is removably connectable to device 300 via, for example, a port (e.g., a USB port, an IEEE 1394 port, a THUNDERBOLT™ port, etc.) or a drive (e.g., disk drive, flash drive, or solid-state drive etc.). Electronic storage component 340 may also or alternatively include one or more virtual storage resources (e.g., cloud storage, a virtual private network, and/or other virtual storage resources). An electronic storage may store software algorithms, information determined by one or more processors, information received from one or more computing platforms, information received from one or more remote platforms, databases (e.g., structured query language (SQL) databases (e.g., MYSQL®, MARIADB®, MONGODB®), NO-SQL databases, among others), and/or other information enabling a computing platform to function as described herein.

Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator.

Output component 360 enables device 300 to provide output, such as via a display, a speaker, and/or one or more light-emitting diodes.

Communication component 370 enables device 300 to communicate with other devices, such as via a wired connection and/or a wireless connection, for example, via the internet and/or other networks using, for example, TCP/IP or cellular hardware enabling wired or wireless (e.g., cellular, 2G, 3G, 4G, 4G LTE, 5G, or WiFi) communication. For example, communication component 370 may include a receiver, a transmitter, a transceiver, a modem, a network interface card, and/or an antenna.

As used herein, “internet” may include an interconnected network of systems and a suite of protocols for the end-to-end transfer of data therebetween. A model describing may be the Transport Control Protocol and Internet Protocol (TCP/IP), which may also be referred to as the internet protocol suite. TCP/IP provides a model of four layers of abstraction: an application layer, a transport layer, an internet layer, and a link layer. The link layer may include hosts accessible without traversing a router, and thus may be determined by the configuration of the network (e.g., a hardware network implementation, a local area network, a virtual private network, or a networking tunnel). The link layer may be used to move packets of data between the internet layer interfaces of different hosts on the same link. The link layer may interface with hardware for end-to-end transmission of data. The internet layer may include the exchange of datagrams across network boundaries (e.g., from a source network to a destination network), which may be referred to as routing, and is performed using host addressing and identification over an internet protocol (IP) addressing system (e.g., IPv4, IPv6). A datagram may include a self-contained, independent, basic unit of data, including a header (e.g., including a source address, a destination address, and a type) and a payload (e.g., the data to be transported), to be transferred across a packet-switched network. The transport layer may utilize the user datagram protocol (UDP) to provide for basic data channels (e.g., via network ports) usable by applications for data exchange by establishing end-to-end, host-to-host connectivity independent of any underlying network or structure of user data. The application layer may include various user and support protocols used by applications users may use to create and exchange data, utilize services, or provide services over network connections established by the lower layers, including, for example, routing protocols, the hypertext transfer protocol (HTTP), the file transfer protocol (FTP), the simple mail transfer protocol (SMTP), and the dynamic host configuration protocol (DHCP). Such data creation and exchange in the application layer may utilize, for example, a client-server model or a peer-to-peer networking model. Data from the application layer may be encapsulated into UDP datagrams or TCP streams for interfacing with the transport layer, which may then effectuate data transfer via the lower layers.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In addition to the example configuration described herein in FIG. 3, various steps, functions, and/or operations of device 300 and the methods disclosed herein may be carried out by one or more of, for example, electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link.

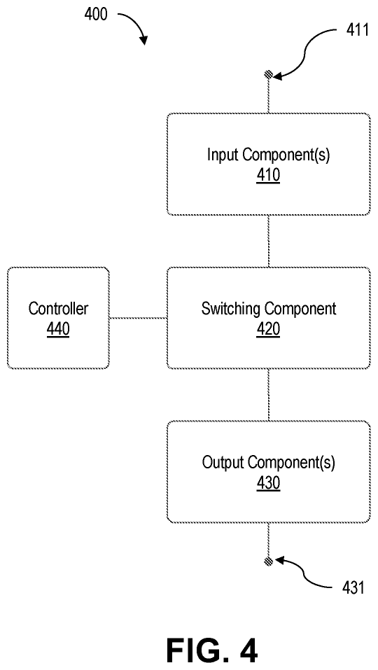

FIG. 4 is a diagram of example components of a device 400. Device 400 may correspond to user device 210 and/or application server 230 or one or more components thereof or linking the same. In some implementations, user device 210 and/or application server 230 may include one or more devices 400 and/or one or more components of device 400. As shown in FIG. 4, device 400 may include one or more input components 410 (hereinafter referred to collectively as input components 410, and individually as input component 410), a switching component 420, one or more output components 430 (hereinafter referred to collectively as output components 430, and individually as output component 430), and a controller 440.

Input component 410 may be one or more points of attachment for input physical link(s) 411 (hereinafter referred to collectively as input physical links 411, and individually as input physical link 411) and may be one or more points of entry for incoming traffic, such as packets. Input component 410 may process incoming traffic, such as by performing data link layer encapsulation or decapsulation. In some implementations, input component 410 may transmit and/or receive packets. In some implementations, input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, device 400 may include one or more input components 410.

Switching component 420 may interconnect input components 410 with output components 430. In some implementations, switching component 420 may be implemented via one or more crossbars, via busses, and/or with shared memories. The shared memories may act as temporary buffers to store packets from input components 410 before the packets are eventually scheduled for delivery to output components 430. In some implementations, switching component 420 may enable input components 410, output components 430, and/or controller 440 to communicate with one another.

Output component 430 may store packets and may schedule packets for transmission on output physical link(s) 431 (hereinafter referred to collectively as output physical links 431, and individually as output physical link 431). Output component 430 may support data link layer encapsulation or decapsulation, and/or a variety of higher-level protocols. In some implementations, output component 430 may transmit packets and/or receive packets. In some implementations, output component 430 may include an output line card that includes one or more packet processing components (e.g., in the form of integrated circuits), such as one or more IFCs, packet forwarding components, line card controller components, output ports, processors, memories, and/or output queues. In some implementations, device 400 may include one or more output components 430. In some implementations, input component 410 and output component 430 may be implemented by the same set of components (e.g., and input/output component may be a combination of input component 410 and output component 430).

Controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, controller 440 may include one or more processors that can be programmed to perform a function.

In some implementations, controller 440 may include a RAM, a ROM, and/or another type of dynamic or static storage device (e.g., a flash memory, a magnetic memory, an optical memory, etc.) that stores information and/or instructions for use by controller 440.

In some implementations, controller 440 may communicate with other devices, networks, and/or systems connected to device 400 to exchange information regarding network topology. Controller 440 may create routing tables based on the network topology information, may create forwarding tables based on the routing tables, and may forward the forwarding tables to input components 410 and/or output components 430. Input components 410 and/or output components 430 may use the forwarding tables to perform route lookups for incoming and/or outgoing packets.

Controller 440 may perform one or more processes described herein. Controller 440 may perform these processes in response to executing software instructions stored by a non-transitory computer-readable medium. A computer-readable medium is defined herein as a non-transitory (e.g., the medium itself (i.e., tangible, not a signal) as opposed to a limitation on data storage persistency (e.g., RAM vs. ROM)) memory device. A memory device includes memory space within a single physical storage device or memory space spread across multiple physical storage devices.

Software instructions may be read into a memory and/or storage component associated with controller 440 from another computer-readable medium or from another device via a communication interface. When executed, software instructions stored in a memory and/or storage component associated with controller 440 may cause controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

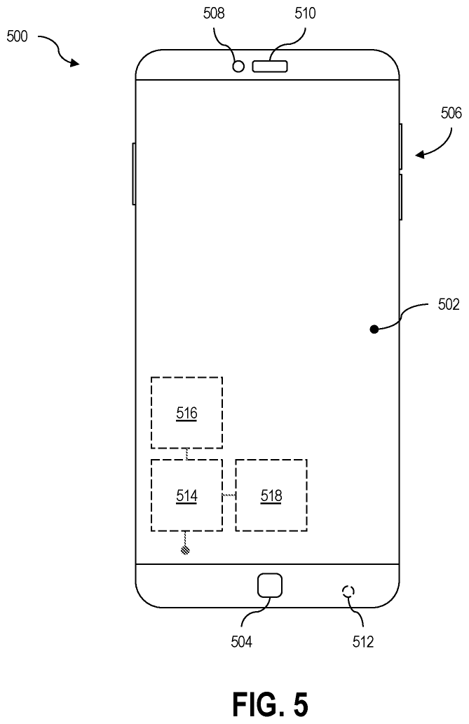

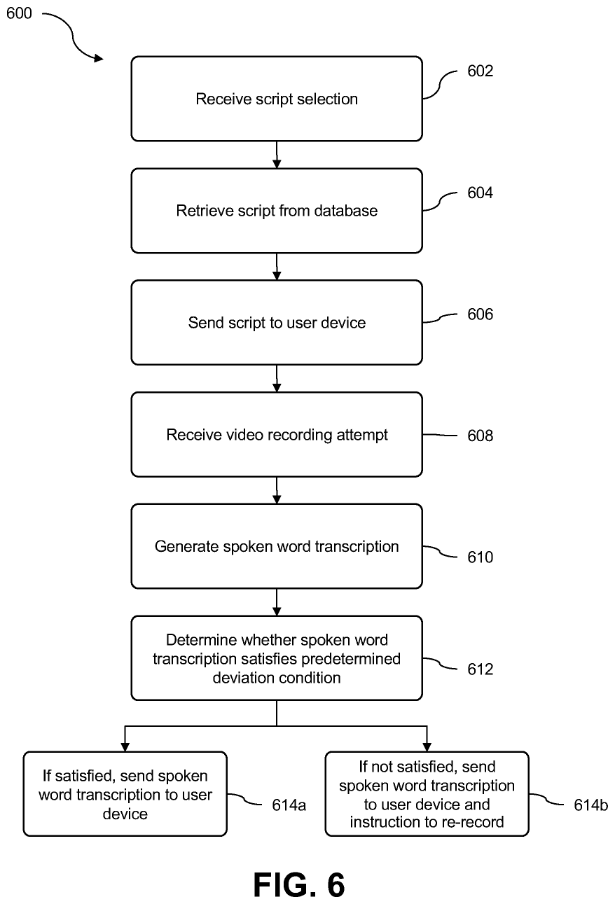

FIG. 5 illustrates example components of a device 500, which may correspond to user device 210 and/or application server 230. While in FIG. 5, device 500 is depicted as a smartphone, it will be understood that device 500 may include various devices, such as, for example, one or more of a server, a desktop computer, a laptop computer, a handheld computer, a tablet computing platform, a Netbook, a Smartphone, a gaming console, and/or other computing platforms.

Device 500 may be configured to communicate with other devices or remote platforms via one or more devices such as device 300 or device 400, and/or according to a client/server architecture, a peer-to-peer architecture, and/or other architectures.

Device 500 may include various components, all or some of which may be used in operation or use of Device 500. Such components may include, inter alia, a display 502, a face button 504, side button 506, a camera 508, a speaker 510, a microphone 512, a processor 514, an electronic storage 516, and a network interface 518. It will be understood that not all of these components are required for every embodiment of device 500, and there may be more than one of any given component in various embodiments of device 500.

Device 500 may include one or more processors configured to execute computer program modules. The computer program modules may be configured to enable a user associated with device 500 to interface with a system, (e.g., similar to device 300) and/or external resources, and/or provide other functionality attributed herein to device 500.

Device 500 may include electronic storage 516, one or more processor(s) 514, and/or other components. Device 500 may include communication lines, or ports to enable the exchange of information with a network and/or other computing platforms (e.g., network interface 518). Illustration of device 500 in FIG. 5 is not intended to be limiting. Device 500 may include a plurality of hardware, software, and/or firmware components operating together to provide the functionality attributed herein to device 500. For example, device 500 may be implemented by a cloud of computing platforms operating together as device 500.

Electronic storage 516 may be directly or indirectly in operative electronic communication with processor 514 may comprise non-transitory storage media that electronically stores information. The electronic storage media of electronic storage 516 may include one or both of system storage that is provided integrally (i.e., substantially non-removable) with device 500 and/or removable storage that is removably connectable to device 500 via, for example, a port (e.g., a USB port, an IEEE 1394 port, a THUNDERBOLT™ port, etc.) or a drive (e.g., a disk drive, flash drive, or solid-state drive etc.). Electronic storage 516 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 516 may include one or more virtual storage resources (e.g., cloud storage, a virtual private network, and/or other virtual storage resources). Electronic storage 516 may store software algorithms, information determined by processor(s) 516, information received from device 516, information received from the system or another remote platform, and/or other information that enables device 516 to function as described herein.

Processor(s) 514 may be configured to provide information processing capabilities in device 500. As such, processor(s) 514 may include one or more of a digital processor, an analog processor, a digital circuit designed to process information, an analog circuit designed to process information, a state machine, and/or other mechanisms for electronically processing information. Although processor(s) 514 is shown in FIG. 5 as a single entity, this is for illustrative purposes only. In some embodiments, processor(s) 514 may include a plurality of processing units. These processing units may be physically located within the same device, or processor(s) 514 may represent processing functionality of a plurality of devices operating in coordination. Processor(s) 514 may be configured to execute one or more of the modules disclosed herein, and/or other modules. Processor(s) 514 may be configured to execute one or more of the modules disclosed herein, and/or other modules by software; hardware; firmware; some combination of software, hardware, and/or firmware; and/or other mechanisms for configuring processing capabilities on processor(s) 514. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using ActiveX controls, model-view-controller (MVC) principles, application programming interfaces (APIs), system-specific programming languages and principles, cross-platform programming languages and principles, pre-compiled programming languages, “bytecode” programming languages, object-oriented programming principles or languages, other programming principles or languages, JavaBeans, Microsoft Foundation Classes (MFC), Streaming SIMD Extension (SSE), or other technologies or methodologies, as desired.

It should be appreciated that although the modules disclosed herein are illustrated in FIG. 5 as being implemented within a single processing unit, in embodiments in which processor(s) 514 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, processor(s) 514 may be configured to execute one or more additional modules that may perform some or all of the functionality attributed herein to one of modules disclosed herein.

Device 500 may be configured by machine-readable instructions. Such machine-readable instructions may include one or more instruction modules. The instruction modules may include computer program modules, which may be similar to, for example, at least a portion of the methods described herein. The instruction modules may include one or more of the modules and methods disclosed herein and/or other instruction modules and methods.

A network interface 518 may be directly or indirectly in operative electronic communication with, inter alia, processor 514. Network interface 518 may operatively link processor 514 and/or device 500 with one or more other computing platform(s), remote platform(s), and/or external resources via one or more electronic communication links. For example, such electronic communication links may be established, at least in part, via a network such as the internet and/or other networks using, for example, TCP/IP or cellular hardware enabling wired or wireless (e.g., cellular, 2G, 3G, 4G, 4G LTE, 5G, or WiFi) communication. It will be appreciated that this is not intended to be limiting, and that the scope of this disclosure includes embodiments in which device 500, one or more other computing platform(s), remote platform(s), and/or external resources may be operatively linked via some other communication media.

Processor 514 may be directly or indirectly in operative electronic communication with display 502. Display 502 may include a device (or “hardware component”) that displays “display data” to form an image or images, such as, but not limited to, a picture, text, a desktop background, a gaming background, a video, an application window etc. One example of display 502 may include an integrated display as found in electronic devices such as handheld computing devices, electronic book readers, mobile telephones (smartphones), personal-digital-assistants (PDAs), wearable devices (smart-watches, smart-glasses, etc.). Display 502 may employ any appropriate display technology, such as for example, LCD flat panel, LED flat panel, flexible-panels, etc., and may include other display hardware that may, as needed for a particular electronic device, be operatively coupled to other devices and components. Therefore, display 502 may include display hardware such as, but not limited to, a frame buffer, hardware display drivers, etc. that store and refresh display data to be displayed by display 502. Also, display 502 may include integrated hardware for implementation of touchscreen functionality such that the display is operative to receive user input by touch or via a stylus.

The term “image” as used herein may refer generally to what is “displayed” on a display (e.g., display 502) and which may be stored in memory as “display data.” That is, an image may be displayed on a display by sending the appropriate display data to the display. Examples of images may include, but are not limited to, a background or “wallpaper,” a gaming background, a video, an application window, an icon, a widget, etc. In other words, the term “image” may refer to a background, or may refer individually, or collectively, to elements or objects in the foreground hovering over a background image such as wallpaper. The term “display data” may be used interchangeably herein with the term “image data” and refers to the information (data, or digital information) that the display interprets and/or decodes to show (i.e., to display) the user an image, as well as any associated elements or objects in the foreground of the background or wallpaper, etc.

Processor 514 may be directly or indirectly in operative electronic communication with face button 504 and/or side buttons 506. Face button 504 and/or side buttons 506 may be configured to perform a variety of functions in relation to device 500.

Processor 514 may be directly or indirectly in operative electronic communication with camera 508. Camera 512 may include a single camera, multiple cameras, or a camera array. Camera 512 may operate by electronically capturing reflected light from objects and assigning quantitative values to one or more aspects of the reflected light, such as pixels. Camera 512 may include one or more sensors having one or more filters associated therewith. The sensors of camera 512 may capture information regarding any number of pixels of the reflected light corresponding to one or more base colors (e.g., red, green or blue) expressed in the reflected light, and store values associated with the pixel colors as image data and/or transmit image data to another device for further analysis or reproduction. The camera may also be configured to determine depth information, such as the distance between the camera and an object in the field of view of the camera. Depth information may be included in the image data generated by the camera.

Processor 514 may be directly or indirectly in operative electronic communication with speaker 510. Speaker 512 may include a single speaker, multiple speakers, or a speaker array. Processor 514 may be directly or indirectly in operative electronic communication with microphone 512. Microphone 512 may include a single microphone, multiple microphones, or a microphone array.

FIG. 6 is a flowchart illustrating an example method 600, according to one or more implementations herein. In some implementations, one or more operations illustrated in FIG. 6 may be performed by a user device 210, a networking device, and/or application server 230. In some implementations, one or more operations illustrated in FIG. 6 may be performed by another device or a group of devices separate from or including the network device (e.g., user device 210, a networking device facilitating network 220, and/or application server 230), such as a server device (e.g., application server 230).

An operation 602 may include receiving a script selection, and may be performed alone or in combination with one or more other operations depicted in FIG. 6. The script selection may be selected using a processor or may be received from a user device.

An operation 604 may include retrieving a script selection from a database, and may be performed alone or in combination with one or more other operations depicted in FIG. 6. The database may be stored on an electronic storage device in electronic communication with the processor. The retrieval of the script may be based on the script selection

An operation 606 may include sending the script to a user device via a network interface in electronic communication with the processor, and may be performed alone or in combination with one or more other operations depicted in FIG. 6.

An operation 608 may include receiving a video recording attempt from the user device via the network interface, and may be performed alone or in combination with one or more other operations depicted in FIG. 6.

An operation 610 may include generating, using a trained transcription machine learning model, a spoken word transcription from an audio track of the video recording attempt, the spoken word transcription including a deviation or the spoken word transcription from the script, and may be performed alone or in combination with one or more other operations depicted in FIG. 6.

An operation 612 may include determining, based on the deviation, whether the spoken word transcription satisfies a predetermined deviation condition, and may be performed alone or in combination with one or more other operations depicted in FIG. 6.

An operation 614a may include, if the video recording attempt satisfies the predetermined deviation condition, sending the spoken word transcription to the user device via the network interface, and may be performed alone or in combination with one or more other operations depicted in FIG. 6.

An operation 614b may include, if the video recording attempt does not satisfy the predetermined deviation condition, sending the spoken word transcription and an instruction to re-record the video to the user device via the network interface, and may be performed alone or in combination with one or more other operations depicted in FIG. 6.

Although FIG. 6 depicts an example methods 600 and operations thereof, in some implementations, a method illustrated herein may include additional operations, fewer operations, differently arranged operations, or different operations than the operations depicted in FIG. 6. Moreover, or in the alternative, two or more of the operations depicted in FIG. 6 may be performed at least partially in parallel.

Implementations may implement machine learning, a type of artificial intelligence (AI) that provides computers with an ability to learn how to process data without being explicitly programmed. Machine learning focuses on the development of computer programs that can teach themselves to grow and change when exposed to new data. Machine learning explores the study and construction of algorithms that can learn from and make predictions based on data. Such algorithms may overcome following strictly static program instructions by making data-driven predictions or decisions, through building a model from sample inputs.

Machine learning may refer to a variety of AI software algorithms, which may be used to perform supervised learning, unsupervised learning, reinforcement learning, deep learning, or any combination thereof. A variety of different machine learning algorithms may be employed in implementations. Examples of machine learning algorithms may include, inter alia, artificial neural network algorithms, Gaussian process regression algorithms, fuzzy logic-based algorithms, or decision tree algorithms.

In some implementations, more than one machine learning algorithm may be employed. For example, automated classification may be implemented using one type of machine learning algorithm, and adaptive real-time process control may be implemented using a different type of machine learning algorithm. In some implementations, hybrid machine learning algorithms including features and properties drawn from two, three, four, five, or more different types of machine learning algorithms may be employed in implementations.

Supervised learning algorithms may use labeled training data to infer a relationship between one or more identifiable aspects of a given entity and a classification of the entity according to a specified set of criteria or to infer a relationship between input process control parameters and desired outcomes. The training data may include paired training examples. For example, each training data example may include aspects identified for a given entity and the resultant classification of the given entity. As a further example, each training data example may include process control parameters used in a process and a known outcome of the process.

Unsupervised learning algorithms may be used to draw inferences from training data including entity data not paired with labeled entity classification data, or input process control parameter data not paired with labeled process outcomes. An example unsupervised learning algorithm is cluster analysis, which may be used for exploratory data analysis to find hidden patterns or groupings in process data.

Semi-supervised learning algorithms may use both labeled and unlabeled object classification or process data for training. Semi-supervised learning algorithms may typically use a small amount of labeled data with a large amount of unlabeled data.

Reinforcement learning algorithms may be used, for example, to optimize a process (e.g., steps or actions of the process) to maximize a process reward function or minimize a process loss function. In machine learning environments, reinforcement learning algorithms may be formulated as Markov decision processes. Reward functions or loss functions, which may also be referred to as cost functions or error functions, may map values of one or more process variables and/or outcomes to a real number that represents a reward or cost, respectively, associated with a given process outcome or event. Examples of process parameters and process outcomes include, inter alia, process throughput, process yield, production quality, or production cost. In some cases, the definition of the reward or loss function to be maximized or minimized, respectively, may depend on the choice of machine learning algorithm used to run the process control method, or vice versa. For example, if an objective is to maximize a total reward/value function, a reinforcement learning algorithm may be chosen. If the objective is to minimize a mean squared error loss function, a decision tree regression algorithm or linear regression algorithm may be chosen. In general, the machine learning algorithm used to run the process control method will seek to optimize the reward function or minimize the loss function by identifying the current state of the process; comparing the current state to the reference state, which may be a target intermediate or final state; and adjusting one or more process control parameters to minimize a difference between the two states. This adjustment may include reference to past learning provided by a training data set. Reinforcement learning algorithms differ from supervised learning algorithms in that correct training data input/output pairs are not presented, nor are sub-optimal actions explicitly corrected. Implementations of these algorithms tend to focus on real-time performance by finding a balance between exploration of possible outcomes based on updated input data and exploitation of past training.

Deep learning, which may also be known as deep structured learning, hierarchical learning, or deep machine learning, may be based on a set of algorithms that attempt to model high level abstractions in data. Deep learning algorithms may be inspired by the structure and function of the human brain and are part of a broader family of machine learning methods based on learning representations of data. Rooted in neural network technology, deep learning may involve a probabilistic graph model having many neuron layers, commonly known as a deep architecture. Deep learning technology may process information such as, inter alia, image, text, or sound information in a hierarchical manner. An observation (e.g., a feature to be extracted for reference) can be represented in many ways including, for example, a vector of intensity values, a set of edges, regions of shape, or in another abstract manner. Some representations may simplify the learning task (e.g., face recognition or facial expression recognition). Deep learning can provide efficient algorithms for unsupervised or semi-supervised feature learning and hierarchical feature extraction. implementations employing deep learning can further benefit from the advantage of deep learning concepts in solving a normally intractable representation inversion problem.

A deep learning module may be configured as a neural network. The deep learning module may further be a deep neural network with a set of weights that model the world based on training using training data. Neural networks can be understood to implement a computational approach-based on a relatively large collection of neural units—to loosely model the way a human brain solves problems with large clusters of biological neurons connected by axons. Each neural unit may be connected to one or more others, and links can be enforcing or inhibitory in their effect on the activation state of connected neural units. These systems may be self-learning and trained rather than explicitly programmed. Neural network systems excel in areas where a solution or feature detection is difficult to express in a traditional computer program.

An example of a deep learning algorithm may be an artificial neural network (ANN). Large ANNs including many layers may be used, for example, to map entity data to entity classification decisions or to map input process control parameters to desired process outcomes. ANNs will be discussed in further detail below.

Neural networks typically include multiple layers, and the signal path may traverse from front to back. The goal of neural networks may be to solve problems in a similar manner to the human brain, although several neural networks may be much more abstract. In a simple example of a neural network, there may be two layers (i.e., sets) of neurons: an input layer that receives an input signal and an output layer that sends an output signal. When the input layer receives an input, it may pass a modified version of the input to the next layer. In a deep network, there may be many layers between the input layer and output layer, allowing the algorithm to use multiple processing layers, which may include multiple linear and non-linear transformations. Modern neural networks typically work with a few thousand to a few million neural units and millions of connections. Neural networks may have various suitable architectures and/or configurations known in the art.

There are many variants of neural networks with deep architecture depending on the probability specification and network architecture, including, inter alia, deep belief networks (DBN), restricted Boltzmann machines (RBM), random forests, and autoencoders. Implementations of neural networks may vary depending on the size of input data, the number of features to be analyzed, and the nature of the problem. Other layers may be included in the deep learning module besides the neural networks disclosed herein.

Another type of deep neural network may be a convolutional neural network (CNN), which can be used for analysis of an entity or process. CNNs are commonly composed of layers of different types: convolution, pooling, upscaling, and fully connected layers. In some cases, an activation function such as a rectified linear unit (ReLU) function may be used in some of the layers. In a CNN architecture, there can be one or more layers for each type of operation performed. A CNN architecture may include any number of layers in total, and any number of layers for the different types of operations performed. The simplest CNN architecture starts with an input layer followed by a sequence of convolutional layers and pooling layers (e.g., layers otherwise configured for reducing the dimensionality of the feature map generated by the one or more convolutional layers while retaining the most important features, for example, max pooling layers) and ends with fully connected layers (e.g., a layer in which each of the nodes is connected to each of the nodes in the previous layer). Each convolution layer may include a plurality of parameters used for performing the convolution operations. Each convolution layer may also include one or more filters, which in turn may include one or more weighting factors or other adjustable parameters. In some instances, the parameters may include biases (e.g., parameters that permit an activation function to be shifted). In some cases, the convolutional layers may be followed by an ReLU activation function layer. Other activation functions can also be used, for example, inter alia, saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid functions. The convolutional, pooling and ReLU layers may function as learnable feature extractors, while the fully connected layers may function as machine learning classifiers. As with other artificial neural networks, the convolutional layers and fully connected layers of CNN architectures may include various computational parameters, for example, weights, bias values, and threshold values, which may be trained in a training phase.

Another type of deep neural network may be a visual geometry group (VGG) network. For example, VGG networks may be created by increasing the number of convolutional layers while fixing other parameters of the architecture. Adding convolutional layers to increase depth may be made possible by using substantially small convolutional filters in all of the layers. VGG networks may also include convolutional layers followed by fully connected layers.

Another type of deep neural network may be a deep residual network. Like some other networks described herein, a deep residual network may include convolutional layers followed by fully connected layers, which may be, in combination, configured and trained for feature property extraction. A deep residual network's layers may be configured to learn residual functions with reference to layer inputs, instead of learning unreferenced functions. Instead of relying on a direct fit of few stacked layers to a desired underlying mapping, a deep residual network's layers may be explicitly allowed to fit a residual mapping, which may be realized by feedforward neural networks having shortcut connections (i.e., connections that skip one or more layers). A deep residual network may be created by inserting shortcut connections into a plain neural network structure including convolutional layers, thereby modifying the plain neural network into a residual learning network.

In some implementations, the machine learning module may include a support vector machine (SVM), an artificial neural network (ANN), a decision tree-based expert learning system, an autoencoder, a clustering machine learning algorithm, or a nearest neighbor (e.g., kNN) machine learning algorithm, or combinations thereof, some of which will be described in further detail below.

Support vector machines (SVMs) may be supervised learning algorithms used for classification and regression analysis of entity classification data or process control. Given a set of training data examples (e.g., entity or process data), each marked as belonging to a category, an SVM training algorithm may build a model that assigns new examples (e.g., data from a new entity or process) to a given category.

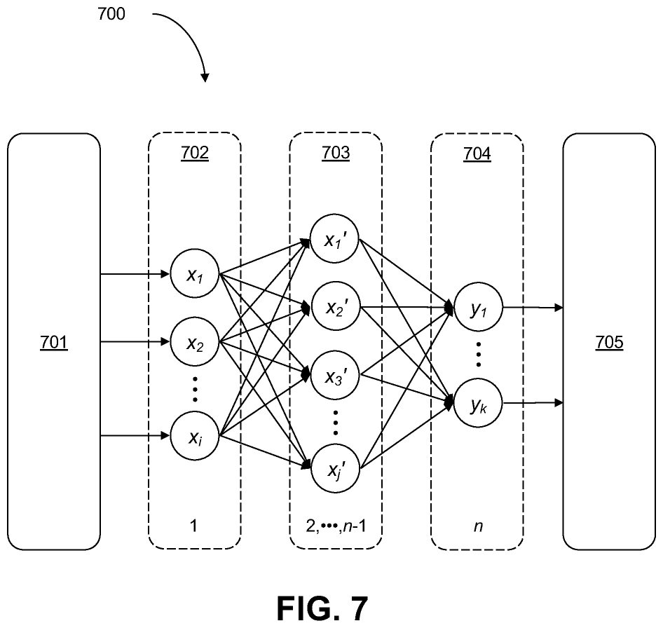

FIG. 7 illustrates an artificial neural network (ANN) 700, according to an implementation. ANN 700 may be used for, inter alia, classification or process control optimization according to various implementations.

ANN 700 may include any type of neural network module, such as, inter alia, a feedforward neural network, radial basis function network, recurrent neural network, or convolutional neural network.

In implementations implementing ANN 700 for entity classification, ANN 700 may be employed to map entity data to entity classification data. In implementations implementing ANN 700 for process optimization, ANN 700 may be employed to determine an optimal set or sequence of process control parameter settings for adaptive control of a process in real-time based on a stream of process monitoring data and/or entity classification data provided by, for example, observation or from one or more sensors. ANN 700 may include an untrained ANN, a trained ANN, pre-trained ANN, a continuously updated ANN (e.g., an ANN utilizing training data that is continuously updated with real time classification data or process control and monitoring data from a single local system, from a plurality of local systems, or from a plurality of geographically distributed systems).

ANN 700 may include interconnected nodes (e.g., x₁-xᵢ, x₁′-xⱼ′, and y₁-yₖ) organized into n layers of nodes, where x₁-xᵢ represents a group of i nodes in a first layer 702 (e.g., layer 1), x₁-xⱼ′ represents a group of j nodes in a hidden layer 703 (e.g., layer(s) 2 through n−1), and y₁-yₖ represents a group of k nodes in a final layer 704 (e.g., layer n). Input layer 702 may be configured to receive input data 701 (e.g., sensor data, image data, sound data, observed data, automatically retrieved data, manually input data, etc.). Final layer 704 may be configured to provide result data 705.

There may be one or multiple hidden layers 703, and the number j of nodes in each hidden layer 703 may vary from implementation to implementation. Thus, ANN 700 may include any total number of layers (e.g., any number of hidden layers 703). One or more of hidden layers 703 may function as trainable feature extractors, which may allow mapping of input data 701 to preferred result data 705.

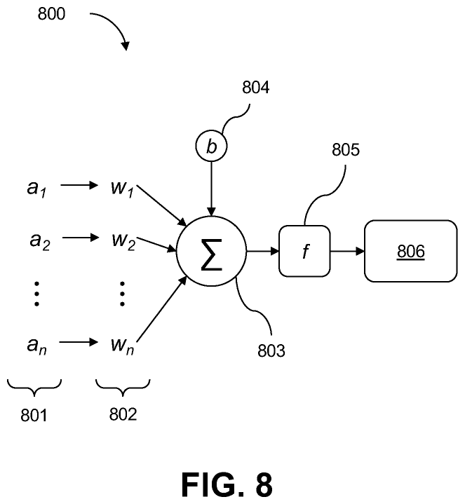

FIG. 8 illustrates a node 800, according to an implementation. Each layer of a neural network may include one or more nodes similar to node 800, for example, nodes x₁-xᵢ, x₁′-xⱼ′, and y₁-yₖ depicted in FIG. 7. Each node may be analogous to a biological neuron.

Node 800 may receive node inputs 801 (e.g., a₁-aₙ) either directly from the ANN's input data (e.g., input data 701) or from the output of one or more nodes in a different layer or the same layer. With node inputs 801, the node 800 may perform an operation 803, which while depicted in FIG. 8 as a summation operation, would be readily understood to include various other operations known in the art.

In some cases, node inputs 801 may be associated with one or more weights 802 (e.g., w₁-wₙ), which may represent weighting factors. For example, operation 803 may sum the products of each of node inputs 801 and associated weights 802 (e.g., aᵢwᵢ).

The result of operation 803 may be offset with a bias 804 (e.g., bias b), which may be a value or a function.

Output 806 of node 800 may be gated using an activation (or threshold) function 805 (e.g., function f), which may be a linear or a nonlinear function. Activation function 805 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

Weights 802, biases 804, or threshold values of activation functions 805, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control.

Decision tree-based expert systems may be supervised learning algorithms designed to solve entity classification problems or process control problems by applying a series of conditional (e.g., if-then) rules. Expert systems may include two subsystems: an inference engine and a knowledge base. The knowledge base may include a set of facts (e.g., a training data set including entity data for a series of entities, and the associated entity classification data provided by, for example, a skilled operator, technician, or inspector) and derived rules (e.g., derived entity classification rules). The inference engine may then apply the rules to input data for a current entity classification problem or process control problem to determine a classification of the entity or a next set of process control adjustments.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

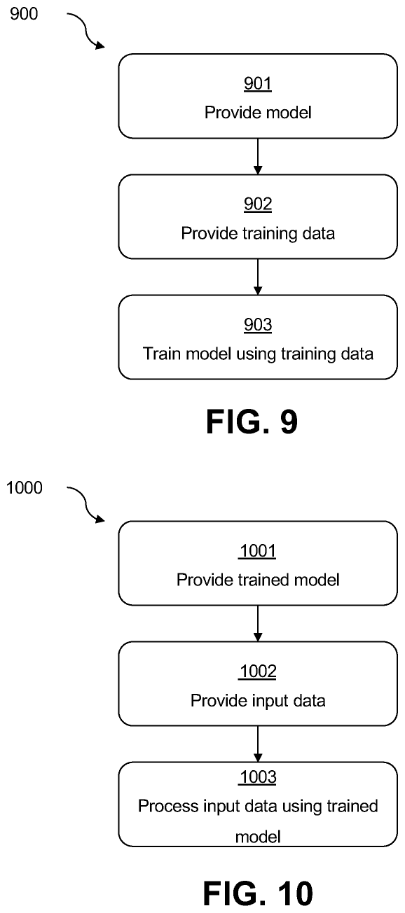

FIG. 9 illustrates a method 900 of training a machine learning model of a machine learning module, according to an implementation. Use of method 900 may provide for use of training data to train a machine learning model for concurrent or later use.

At 901, a machine learning model including one or more machine learning algorithms may be provided.

At 902, training data may be provided. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. One or more sets of training data may be used to train the machine learning algorithm used for object defect detection and classification. In some cases, the type of data included in the training data set may vary depending on the specific type of machine learning algorithm employed.

At 903, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

FIG. 10 illustrates a method 1000 of analyzing input data using a machine learning module, according to an implementation. Use of the machine learning module described by method 1000 may enable, for example, automatic classification of an entity or optimized process control.

At 1001, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to ANN 700, include nodes similar to node 800, and may have been trained (or be under continuous or periodic training) using a method similar to method 900.

At 1002, input data may be provided to the machine learning module for input into the machine learning model. The input data may result from or be derived from a variety of different sources, similar to input data 701.

The provision of input data at 1002 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 1002 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 1003, the machine learning module may process the input data using the trained machine learning model to yield results from the machine learning module. Such results may include, for example, an entity classification or one or more optimized process control parameters.

Various characteristics, advantages, implementations, embodiments, and/or examples relating to the invention have been described in the foregoing description with reference to the accompanying drawings. However, the above description and drawings are illustrative only. The invention is not limited to the illustrated implementations, embodiments, and/or examples, and all implementations, embodiments, and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described implementations, embodiments, and/or examples can be rearranged and combined in manners other than specifically described above, with any and all permutations within the scope of the invention, as limited only by the appended claims.

In the claims, various portions may be prefaced with letter or number references for convenience. However, use of such references does not imply a temporal or ordered relationship not otherwise required by the language of the claims. Unless the phrase ‘means for’ or ‘step for’ appears in a particular claim or claim limitation, such claim or claim limitation should not be interpreted to invoke 35 U.S.C. § 112 (f).

As used herein, satisfying a threshold may, depending on the context, refer to a value being greater than the threshold, greater than or equal to the threshold, less than the threshold, less than or equal to the threshold, equal to the threshold, and/or the like, depending on the context.

As used in the specification and in the claims, use of “and” to join elements in a list forms a group of all elements of the list. For example, a list described as comprising A, B, and C defines a list that includes A, includes B, and includes C. As used in the specification and in the claims, use of “or” to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list. As used in the specification and in the claims, the singular form of ‘a’, ‘an’, and ‘the’ include plural referents (e.g., one or more of the referent) unless the context clearly dictates otherwise.

It is to be expressly understood that the drawings are for the purpose of illustration and description only and are not intended as a definition of the limits of the invention.

It is to be expressly understood that the drawings are for the purpose of illustration and description only and are not intended as a definition of the limits of the invention.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

What is claimed is:

1. A method, comprising:
with a processor of an application server:
receiving a script selection;
retrieving a script from a database stored on an electronic storage device in electronic communication with the processor based on the script selection;
sending the script to a user device via a network interface in electronic communication with the processor;
receiving a video recording attempt from the user device via the network interface;
generating, using a trained transcription machine learning model, a spoken word transcription from an audio track of the video recording attempt, the spoken word transcription including a deviation of the spoken word transcription from the script;
determining, based on the deviation, whether the spoken word transcription satisfies a predetermined deviation condition; and:
if the video recording attempt satisfies the predetermined deviation condition, sending the spoken word transcription to the user device via the network interface; or
if the video recording attempt does not satisfy the predetermined deviation condition, sending the spoken word transcription and an instruction to re-record the video to the user device via the network interface.

2. The method of claim 1, wherein the script selection includes a plurality of script fragment selections and retrieving the script from the database includes retrieving a plurality of script fragments corresponding to the script fragment selections and compiling the script from the script fragments.

3. The method of claim 1, wherein the deviation includes a severity and the predetermined deviation condition includes whether the severity exceeds a deviation severity threshold.

4. The method of claim 1, wherein the predetermined deviation condition includes whether a restricted word or phrase is present within the spoken word transcription.

5. The method of claim 1, wherein the trained transcription machine learning model is trained using a training audio track and training spoken word transcription corresponding to the training audio track.

6. The method of claim 1, wherein the determining, based on the deviation, whether the spoken word transcription satisfies a predetermined deviation condition includes using a trained deviation evaluation machine learning model.

7. The method of claim 6, wherein the trained deviation evaluation machine learning model is trained using a training spoken word transcription and a training condition evaluation set.

8. The method of claim 1, wherein sending the script to the user device includes formatting the script for teleprompter use.

9. A system, comprising:
a processor of an application server;
an electronic storage device in electronic communication with the processor, the electronic storage device having a database stored thereon; and
a network interface in electronic communication with the processor;
wherein the processor is configured to perform a method comprising:
receiving a script selection;
retrieving a script from the database based on the script selection;
sending the script to a user device via the network interface;
receiving a video recording attempt from the user device via the network interface;
generating, using a trained transcription machine learning model, a spoken word transcription from an audio track of the video recording attempt, the spoken word transcription including a deviation of the spoken word transcription from the script;
determining, based on the deviation, whether the spoken word transcription satisfies a predetermined deviation condition; and:
if the video recording attempt satisfies the predetermined deviation condition, sending the spoken word transcription to the user device via the network interface; or
if the video recording attempt does not satisfy the predetermined deviation condition, sending the spoken word transcription and an instruction to re-record the video to the user device via the network interface.

10. The system of claim 9, wherein the deviation includes a severity and the predetermined deviation condition includes whether the severity exceeds a deviation severity threshold.

11. The system of claim 9, wherein the predetermined deviation condition includes whether a restricted word or phrase is present within the spoken word transcription.

12. The system of claim 9, wherein the trained transcription machine learning model is trained using a training audio track and training spoken word transcription corresponding to the training audio track.

13. The system of claim 9, wherein the determining, based on the deviation, whether the spoken word transcription satisfies a predetermined deviation condition includes using a trained deviation evaluation machine learning model.

14. The system of claim 13, wherein the trained deviation evaluation machine learning model is trained using a training spoken word transcription and a training condition evaluation set.

15. A tangible, non-transient, computer-readable media having instructions thereupon which when implemented by a processor cause the processor to perform a method comprising:
receiving a script selection;
retrieving a script from a database stored on an electronic storage device in electronic communication with the processor based on the script selection;
sending the script to a user device via a network interface in electronic communication with the processor;
receiving a video recording attempt from the user device via the network interface;
generating, using a trained transcription machine learning model, a spoken word transcription from an audio track of the video recording attempt, the spoken word transcription including a deviation of the spoken word transcription from the script;
determining, based on the deviation, the spoken word transcription does not satisfy a predetermined deviation condition; and
sending the spoken word transcription and an instruction to re-record the video to the user device via the network interface.

16. The tangible, non-transient, computer-readable media of claim 15, wherein the deviation includes a severity and the predetermined deviation condition includes whether the severity exceeds a deviation severity threshold.

17. The tangible, non-transient, computer-readable media of claim 15, wherein the predetermined deviation condition includes whether a restricted word or phrase is present within the spoken word transcription.

18. The tangible, non-transient, computer-readable media of claim 15, wherein the trained transcription machine learning model is trained using a training audio track and training spoken word transcription corresponding to the training audio track.

19. The tangible, non-transient, computer-readable media of claim 15, wherein the determining, based on the deviation, whether the spoken word transcription satisfies a predetermined deviation condition includes using a trained deviation evaluation machine learning model.

20. The tangible, non-transient, computer-readable media of claim 19, wherein the trained deviation evaluation machine learning model is trained using a training spoken word transcription and a training condition evaluation set.
